(19) United States
(12) Patent Application Publication
(10) Pub. No.: US 2019/0013543 A1
(43) Pub. Date: Jan. 10, 2019

(54) NONAQUEOUS ELECTROLYTE SECONDARY BATTERY

(71) Applicant: SANYO Electric Co., Ltd., Osaka (JP)

(72) Inventors: Yohei Tao, Hyogo (JP); Mio Nosaka, Hyogo (JP); Masao Inoue, Tokushima (JP); Kunihiko Mineya, Hyogo (JP); Akihito Komatsu, Hyogo (JP)

(73) Assignee: SANYO Electric Co., Ltd., Osaka (JP)

(21) Appl. No.: 16/020,024

(22) Filed: Jun. 27, 2018

(30) Foreign Application Priority Data
Jul. 5, 2017 (JP) 2017-132071

(51) Int. Cl. H01M 10/0525; H01M 10/0569; H01M 4/505; H01M 4/525; H01M 4/583; H01M 4/36; H01M 4/64; H01M 2/26; H01M 2/30; H01M 2/08; H01M 2/16

(52) U.S. Cl. CPC H01M 10/0525; H01M 10/0569; H01M 4/505; H01M 4/525; H01M 4/583; H01M 2/1646; H01M 4/64; H01M 2/26; H01M 2/30; H01M 2/08; H01M 4/364

(57) ABSTRACT

A nonaqueous electrolyte secondary battery includes an electrode assembly including a negative electrode and a positive electrode including a positive electrode active material mix layer containing a lithium-transition metal composite oxide which is a positive electrode active material; a nonaqueous electrolyte; and a battery case that houses the electrode assembly and the nonaqueous electrolyte. The positive electrode active material has a film formed thereon and the film contains 0.04 μmol to 0.19 μmol of sulfur per square meter of the specific surface area of particles of the positive electrode active material.

### CROSS REFERENCE TO RELATED APPLICATIONS

The present invention application claims priority to Japanese Patent Application No. 2017-132071 filed in the Japan Patent Office on July 5, 2017, the entire contents of which are incorporated herein by reference.

### BACKGROUND OF THE INVENTION

### Field of the Invention

The present invention relates to a nonaqueous electrolyte secondary battery.

### Description of Related Art

Nonaqueous electrolyte secondary batteries are used in power supplies for driving hybrid electric vehicles (PHEVs and HEVs) and electric vehicles (EVs) and the like. Needs for the enhancement of the electrical performance of nonaqueous electrolyte secondary batteries used in such power supplies and the like are increasingly growing.

In the case where a nonaqueous electrolyte secondary battery is stored for a long period, there is a problem in that the internal resistance of the nonaqueous electrolyte secondary battery increases and power characteristics of the nonaqueous electrolyte secondary battery decrease. A major cause of the increase in internal resistance of the nonaqueous electrolyte secondary battery is probably that a substance with the charge transfer resistance is formed on a positive electrode active material.

Therefore, it is conceivable that appropriate film is formed on the positive electrode active material for the purpose of suppressing the increase of the substance, formed on the positive electrode active material, having the charge transfer resistance.

Japanese Published Unexamined Patent Application No. 2015-125833 (Patent Document 1) discloses that the amount of SO³⁻ and SO₄²⁻ derived from a sulfonic acid compound is set to 3 μmol to 10 μmol per square meter of the specific surface area of particles of a positive electrode active material.

### BRIEF SUMMARY OF THE INVENTION

It is an object of the present invention to provide a nonaqueous electrolyte secondary battery with a reduced increase in resistance during long-term storage.

A nonaqueous electrolyte secondary battery according to an embodiment of the present invention includes

an electrode assembly including a negative electrode and a positive electrode including a positive electrode active material mix layer containing a lithium-transition metal composite oxide which is a positive electrode active material,

a nonaqueous electrolyte, and

a battery case that houses the electrode assembly and the nonaqueous electrolyte.

The positive electrode active material has a film formed thereon.

The film contains 0.04 μmol to 0.19 μmol of sulfur element per square meter of the specific surface area of particles of the positive electrode active material.

In the nonaqueous electrolyte secondary battery according to an, embodiment of the present invention, setting the amount of sulfur element contained in the film formed on the positive electrode active material to 0.04 μmol of to 0.19 μmol per square meter of the specific surface area of particles of the positive electrode active material allows the film to be optimized and enables the increase in resistance of the nonaqueous electrolyte secondary battery during long-term storage to be suppressed.

The lithium-transition metal composite oxide preferably contains at least one of nickel, cobalt, and manganese.

It is preferable that the lithium-transition metal composite oxide contains nickel, cobalt, and manganese and the ratio of the sum of the amounts of nickel and manganese in the lithium-transition metal composite oxide to the sum of the amounts of transition metals in the lithium-transition metal composite oxide is 0.6 or more on a mole basis.

The film is preferably at least one derived from lithium fluorosulfonate.

It is preferable that the film further contains boron element and the film contains 0.02 μmol to 0.04 μmol of boron element per square meter of the specific surface area of particles of the positive electrode active material.

The film is preferably at least one derived from lithium fluorosulfonate and lithium bisoxalato borate.

It is preferable that the film further contains phosphorus element and the film contains 0.24 μmol to 0.30 μmol of phosphorus element per square meter of the specific surface area of particles of the positive electrode active material.

According to the present invention, the increase in resistance of a nonaqueous electrolyte secondary battery during long-term storage is suppressed and a nonaqueous electrolyte secondary battery in which the reduction of power characteristics during long-term storage is suppressed is provided.

### BRIEF DESCRIPTION OF THE SEVERAL VIEWS OF THE DRAWINGS

FIG. 1 is a schematic front view showing the inside of a nonaqueous electrolyte secondary battery according to an embodiment of the present invention except a front portion of a battery case and a front portion of an insulating sheet; and

FIG. 2 is a top view of the nonaqueous electrolyte secondary battery shown in FIG. 1.

### DETAILED DESCRIPTION OF THE INVENTION

Embodiments of the present invention are described below in detail. The embodiments, which are described below, are exemplifications of the present invention. The present invention is not limited to the embodiments.

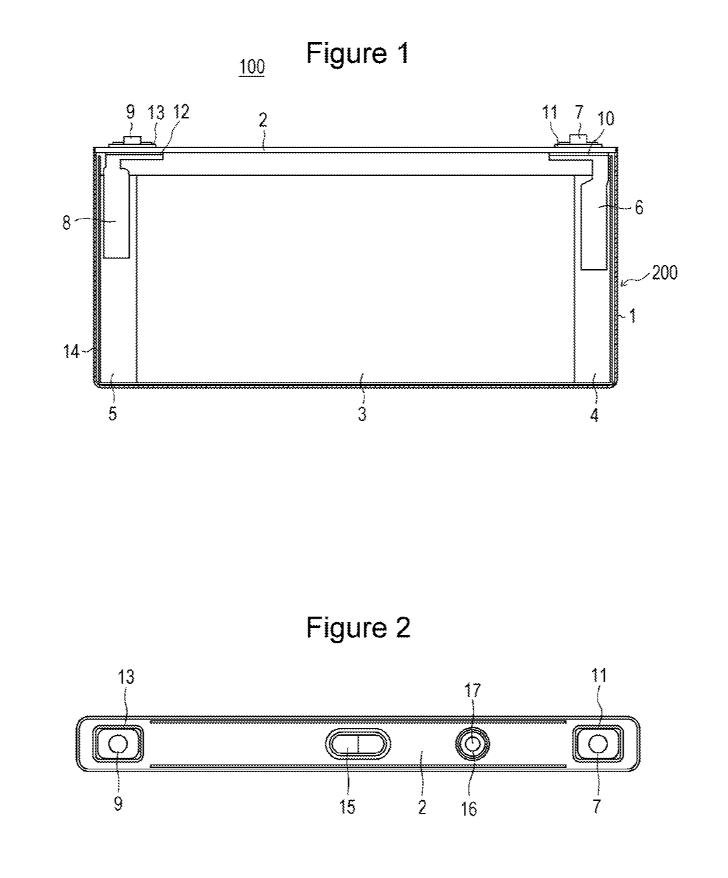

The configuration of a prismatic nonaqueous electrolyte secondary battery 100 according to an embodiment of the present invention is described with reference to FIGS. 1 and 2. As shown in FIGS. 1 and 2, the prismatic nonaqueous electrolyte secondary battery 100 includes an enclosure 1 which has an opening and which has a prismatic bottomed cylindrical shape and a sealing plate 2 for sealing the opening of the enclosure 1. The enclosure 1 and the sealing plate 2 form a battery case 200. The enclosure 1 houses a flat electrode assembly 3 formed by winding a strip-like positive electrode plate and a strip-like negative electrode plate with a strip-like separator therebetween and also houses a nonaqueous electrolyte solution. The electrode assembly 3 includes positive core-exposed portions 4 wound around one end portion thereof and negative core-exposed portions 5 wound around the other end portion.

The positive core-exposed portions 4 are connected to a positive electrode current collector 6. The positive electrode current collector 6 is electrically connected to a positive electrode terminal 7. An inner insulating member 10 is placed between the positive electrode current collector 6 and the sealing plate 2. An outer insulating member 11 is placed between the positive electrode terminal 7 and the sealing plate 2.

The negative core-exposed portions 5 are connected to a negative electrode current collector 8. The negative electrode current collector 8 is electrically connected to a negative electrode terminal 9. An inner insulating member 12 is placed between the negative electrode current collector 8 and the sealing, plate 2. An outer insulating member 13 is placed between the negative electrode terminal 9 and the sealing plate 2.

An insulating sheet 14 is placed between the electrode assembly 3 and the enclosure 1. The sealing plate 2 is provided with a gas release valve 15 that ruptures to release gas in the battery case 200 to the outside of the battery case 200 when the pressure in the battery case 200 reaches a value greater than or equal to a predetermined value. Furthermore, the sealing plate 2 is provided with an electrolyte solution-pouring hole 16. The electrolyte solution-pouring hole 16 is sealed with a sealing plug 17 after the nonaqueous electrolyte solution is poured into the battery case 200.

A method for manufacturing the nonaqueous electrolyte secondary battery 100 is described below.

### Preparation of Positive Electrode Plate

A positive electrode active material which is a lithium-transition metal composite oxide represented by the formula LiNi_{0.35}Co_{0.35}Mn_{0.30}O₂, a conductive agent which is a carbon powder, and a binding agent which is polyvinylidene fluoride (PVdF) are mixed with a dispersion medium which is N-methyl-2-pyrrolidone (NMP), whereby positive electrode mix slurry is prepared. The mass ratio of the positive electrode active material to the conductive agent to the binding agent in the positive electrode mix shiny is 91:7:2.

The positive electrode mix slurry prepared by the above method is applied to both surfaces of aluminium foil, sewing as a positive core, having a thickness of 15 μm using a die coater. Thereafter, the positive electrode mix slurry is dried, whereby the dispersion medium, which is NMP, is removed. Positive electrode active material layers thereby formed are compressed using a pair of compression rollers. In this operation, the positive electrode active material mix layers are compressed such that the compressed positive electrode active material mix layers have a packing density of 2.5 g/cm³. The aluminium foil provided with the positive electrode active material mix layers is cut to a predetermined size such that the positive core-exposed portions 4 are located on both surfaces of a lateral end portion of the aluminium foil along a longitudinal direction and are not covered by the positive electrode active material mix layers, whereby the positive electrode plate is prepared.

### Preparation of Negative Electrode Plate

A negative electrode active material which is a graphite powder, a thickening agent which is carboxymethylcellulose (CMC), and a binding agent which is styrene-butadiene rubber (SBR) are dispersed in water at a mass ratio of 98.8:1.0:0.2, whereby negative electrode mix slurry is prepared.

The negative electrode mix slurry prepared by the above method is applied to both surfaces of copper foil, serving as a negative core, having a thickness of 8 μm using a die coater. Next, the positive electrode mix slurry is dried, whereby a dispersion medium, that is, water is removed. Negative electrode active material mix layers thereby formed are compressed with a roll press so as to have a predetermined thickness. The copper foil provided with the negative electrode active material mix lasers is cut to a predetermined size such that the negative core-exposed portions 5 are located on both surfaces of a lateral end portion of the copper foil along a longitudinal direction and are not covered by the negative electrode active material mix layers, whereby the negative electrode plate is prepared.

### Preparation of Flat Electrode Assembly

The flat electrode assembly 3 is prepared in such a manner that the positive and negative electrode plates prepared by the above methods are wound with the separator therebetween and are then press-formed so as to be flat. The separator is 21 μm thick and has a polypropylene/polyethylene/polypropylene three-layer structure. In this operation, the positive core-exposed portions 4 are wound around one end portion of the flat electrode assembly 3 in a winding axis direction thereof and the negative core-exposed portions 5 are wound around the other end portion.

### Preparation of Nonaqueous Electrolyte Solution

Ethylene carbonate (EC), ethyl methyl carbonate (EMC), and dimethyl carbonate (DMC) are mixed at a volume ratio of 3:3:4 at 25° C. and 1 atm, whereby a solvent mixture is prepared. To the solvent mixture, 1.15 mol/L of LiPE₆ which is a solute is added. Furthermore, lithium bis(oxalato)borate (LiC₄BO₈), lithium difluorophosphate (LiPF₂O₂), and lithium fluorosulfonate (LiFSO₃) are added to the solvent mixture, whereby the nonaqueous electrolyte solution is prepared.

### Attachment of Terminals and Current Collectors to Sealing Plate

The outer insulating member 11 is provided on a battery outside surface around a positive electrode terminal-mounting hole in the sealing plate 2. The inner insulating member 10 and the positive electrode current collector 6 are provided on a battery inside surface around the positive electrode terminal-mounting hole in the sealing plate 2. Thereafter, the positive electrode terminal 7 is inserted into a through-hole in the outer insulating member 11, the positive electrode terminal-mounting hole in the sealing plate 2, a through-hole in the inner insulating member 10, and a through-hole in the positive electrode current collector 6 from the outside. The tip side of the positive electrode terminal 7 is swaged on the positive electrode current collector 6. Thereafter, a swaged portion of the positive electrode terminal 7 is welded to the positive electrode current collector 6. A flange portion 7a of the positive electrode terminal 7 is placed outside the sealing plate 2.

The outer insulating, member 13 is provided on a battery outside surface around a negative electrode terminal-mounting hole in the sealing plate 2. The inner insulating member 12 and the negative electrode current collector 8 are provided on a battery inside surface around the negative electrode terminal-monitoring hole in the sealing plate 2. Thereafter, the negative electrode terminal 9 is inserted into a through-hole in the outer insulating member 13, the negative electrode terminal-mounting hole in the sealing plate 2, a through-hole in the inner insulating member 12, and a through-hole in the negative electrode current collector 8 from the outside. The tip side of the negative electrode terminal 9 is swaged on the negative electrode current collector 8. Thereafter, a swaged portion of the negative electrode terminal 9 is welded to the negative electrode current collector 8.

### Connection of Current Collectors to Electrode Assembly

The positive electrode current collector 6 is welded to the wound positive core-exposed portions 4 of the electrode assembly 3. The negative electrode current collector 8 is welded to the wound negative core-exposed portions 5 of the electrode assembly 3. Welding used may be resistance welding, ultrasonic welding, laser welding, or the like.

Insertion of Electrode Assembly into Enclosure

The electrode assembly 3 is wrapped in the insulating sheet 14, which is made of resin, and is then inserted into the enclosure 1. Thereafter, the enclosure 1 and the sealing plate 2 are welded to each other such that the opening of the enclosure 1 is sealed with the sealing plate 2.

### Pouring and Sealing

The nonaqueous electrolyte solution prepared by the above method is poured into the battery case 200 through the electrolyte solution-pouring hole 16 in the sealing plate 2, followed by sealing the electrolyte solution-pouring hole 16 with the sealing plug 17, which is a blind rivet. The nonaqueous electrolyte secondary battery 100 is prepared as described above.

### EXAMPLE 1

The following electrode plate was used: a positive electrode plate including a positive core and positive electrode active material mix layers containing LiNi_{0.35}Co _{0.35}Mn_{0.30}O₂, serving as a positive electrode active material, having a specific surface area of 1.39 m²/g, the weight of the positive electrode active material mix layers being 9.73 mg per square centimeter of the plan-view area of the positive core. That is, in the positive electrode plate used, the sum of the weights of the positive electrode active material mix layers formed on both surfaces of the positive core that had a plan-view area of 1 cm was 9.73 mg. A nonaqueous electrolyte secondary battery was prepared by the above-mentioned method using the positive electrode plate and a nonaqueous electrolyte solution having a lithium bis(oxalato)borate concentration of 0.05 M, a lithium difluorophosphate concentration of 0.05 M, and a lithium fluorosulfonate content of 1% by mass.

### EXAMPLE 2

The following electrode plate was used: a positive electrode plate including a positive core and positive electrode active material mix layers containing LiN_{0.35}Co_{0.35}Mn_{0.30}O₂, serving as a positive electrode active material, having a specific surface area of 1.03 m²/g, the weight of the positive electrode active material mix layers being 9.36 mg per square centimeter of the plan-view area of the positive core. A nonaqueous electrolyte secondary battery was prepared by the above-mentioned method using the positive electrode plate and a nonaqueous electrolyte solution having a lithium bis(oxalato)borate concentration of 0.05 M, a lithium difluorophosphate concentration of 0.05 M, and a lithium fluorosulfonate content of 2% by mass.

### EXAMPLE 3

The following electrode plate was used: a positive electrode plate including a positive core and positive electrode active material mix layers containing LiNi_{0.35}Co_{0.35}Mn_{0.30}O₂, serving as a positive electrode active material, having a specific surface area of 1.75 m²/g, the weight of the positive electrode active material mix layers being 10.09 mg per square centimeter of the plan-view area of the positive core. A nonaqueous electrolyte secondary battery was prepared by the above-mentioned method using the positive electrode plate and a nonaqueous electrolyte solution having a lithium bis(oxalato)borate concentration of 0.05 M, a lithium difluorophosphate concentration of 0.05 M, and a lithium fluorosulfonate content of 0.5% by mass.

### COMPARATIVE EXAMPLE 1

The following electrode plate was used: a positive electrode plate including a positive core and positive electrode active material mix layers containing LiNi_{0.35}Co_{0.35}Mn_{0.30}O₂, serving as a positive electrode active material, having a specific surface area of 1.75 m²/g, the weight of the positive electrode active material mix layers being 10.09 mg per square centimeter of the plan-view area of the positive core. A nonaqueous electrolyte secondary battery was prepared by the above-mentioned method using the positive electrode plate and a nonaqueous electrolyte solution, having a lithium bis(oxalato)borate concentration of 0.05 M and a lithium difluorophosphate concentration of 0.05 M, containing no lithium fluorosulfonate.

### COMPARATIVE EXAMPLE 2

The following electrode plate was used: a positive electrode plate including a positive core and positive electrode active material mix layers containing LiNi_{0.35}Co_{0.35}Mn_{0.30}O₂, serving as a positive electrode active material, having a specific surface area of 1.03 m²/g, the weight of the positive electrode active material mix layers being 9.36 mg per square centimeter of the plan-view area of the positive core. A nonaqueous electrolyte secondary battery was prepared by the above-mentioned method using the positive electrode plate and a nonaqueous electrolyte solution having a lithium bis(oxalato)borate concentration of 0.05 M, a lithium difluorophosphate concentration of 0.05 M, and a lithium fluorosulfonate content of 4% by mass.

For the nonaqueous electrolyte secondary batteries prepared in Examples 1 to 3 and Comparative Examples 1 and 2, an initial treatment below was carried out. The nonaqueous electrolyte secondary batteries prepared in Examples 1 to 3 and Comparative Examples 1 and 2 had a capacity of 4 Ah.

### Initial Treatment

(1) After constant-current charge was performed with a current of 35 A under 25° C. conditions until the battery voltage reached 3.75 V, constant-voltage charge was performed until the current reached 1 A.
(2) Aging was performed at 75 ° C. for 22 hours.
(3) After constant-current charge was performed with a current of 35 A under 25° C. conditions until the battery voltage reached 4.1 V, constant-voltage charge was performed until the current reached 0.25 A.
(4) After constant-current discharge was performed with a current of 35 A under 25° C. conditions until the battery voltage reached 1.6 V, constant-voltage discharge was performed until the current reached 0.25 A.
(5) After constant-current charge was performed with a current of 35 A under 25° C. conditions until the battery voltage reached 3.14 V, constant-voltage charge was performed until the current reached 0.25 A.
(6) Aging was performed at 75° C. for 27 hours.

For each nonaqueous electrolyte secondary battery initially treated as described above, components of a film formed on the positive electrode active material were investigated by a method below.

### Disassembly of Nonaqueous Electrolyte Secondary Battery

(1) The nonaqueous electrolyte secondary battery was discharged with a current of 4.0 A until the battery voltage reached 2.5 V.
(2) In a glove box, the nonaqueous electrolyte secondary battery was disassembled and the positive electrode plate, the negative electrode plate, and the separator were separated.
(3) A positive electrode specimen with a size of 10 cm×10 cm was cut out of the positive electrode plate, was washed with dimethyl carbonate, and was then dried.

### Inductively Coupled Plasma Emission Spectrometry (ICP Spectrometry)

(1) A positive electrode active material mix layer included in the positive electrode specimen was peeled off from the positive core using pure water.
(2) The peeled positive electrode active material mix layer was added to a solution composed of 10 mL of pure water, 10 mL of hydrochloric acid, and 2 mL of hydrogen peroxide, followed by heating at 120° C. for 1 hour.
(3) After the solution was filtered, a 100 mL volumetric flask was filled up with the solution.
(4) The solution was analyzed using an ICP emission Spectrometer, ICPS-8100, available from Shimadzu Corporation.

Each nonaqueous electrolyte secondary battery initially treated as described above was subjected to a storage test below.

### Storage Test

(1) After the initially treated nonaqueous electrolyte secondary battery was bound and was then charged in a constant current mode with a current of 4 A under 25° C. conditions until the battery reached 3.72 V, the nonaqueous electrolyte secondary battery was charged in a constant voltage mode until the state of charge (SOC) of the nonaqueous electrolyte secondary battery reached 56%.
(2) The nonaqueous electrolyte secondary battery was charged with a current of 110 A for 10 seconds under 25° C. conditions. Incidentally, in the case where the battery voltage reached 4.175 V before the charge time reached 10 seconds, the charge of the nonaqueous electrolyte secondary battery was stopped at that point in time. The initial resistance of the nonaqueous electrolyte secondary battery was calculated in such a manner that the overvoltage determined by charging the nonaqueous electrolyte secondary battery with a current of 110 A at an SOC of 56% was divided by 110 A.
(3) After the nonaqueous electrolyte secondary battery was discharged in a constant current mode with a current of 2 A under 25° C. conditions until the battery voltage reached 3 V, the nonaqueous electrolyte secondary battery was discharged in a constant voltage mode until the total operation time reached 3 hours.
(4) After the nonaqueous electrolyte secondary battery was charged in a constant current mode with a current of 4 A under 25° C. conditions until the battery voltage reached 3.89 V, the nonaqueous electrolyte secondary battery was charged in a constant voltage mode until the SOC thereof reached 80%.
(5) The nonaqueous electrolyte secondary battery was left in a 60° C. thermostatic chamber for 180 days in such a state that the SOC thereof was 80%.
(6) After the nonaqueous electrolyte secondary battery left for 180 days was discharged in a constant current mode with a current of 2 A under 25° C. conditions until the battery voltage reached 3 V, the nonaqueous electrolyte secondary battery was discharged in a constant voltage mode until the total operation time reached 3 hours.
(7) After the nonaqueous electrolyte secondary battery was charged in a constant current mode with a current of 4 A under 25° C. conditions until the battery voltage reached 3.72 V, the nonaqueous electrolyte secondary battery was charged in a constant voltage mode until the SOC thereof reached 56%.
(8) The nonaqueous electrolyte secondary battery was charged with a current of 110 A for 10 seconds under 25° C. conditions. Incidentally, in the case where the battery voltage reached 4.175 V before the charge time reached 10 seconds, the charge of the nonaqueous electrolyte secondary battery was stopped at that point in time. The post-storage resistance of the nonaqueous electrolyte secondary battery was calculated in such a manner that the overvoltage determined by charging the nonaqueous electrolyte secondary battery with a current of 110 A at an SOC of 56% was divided by 110 A.
(9) The rate of increase in resistance of the nonaqueous electrolyte secondary battery during storage was determined by dividing the post-storage resistance by the initial resistance.

For each nonaqueous electrolyte secondary battery, the amount of an element contained in a film per square meter of the specific surface area of particles of the positive electrode active material and results (rate of increase in resistance (%) of the storage test are shown in Table 1. Incidentally, the amount of the element contained in the film per square meter of the specific surface area of particles of the positive electrode active material was calculated in such a manner that the total amount of the content of the element in the film included in the positive electrode specimen was divided by the specific surface area of particles of the positive electrode active material contained in the positive electrode specimen.

TABLE 1

| | Amount of element contained in film | | | |
|---|---|---|---|---|
| | per square meter of specific surface | | | Rate of |
| | area of particles of positive electrode | | | increase in |
| | active material (μmol/m²) | | | resistance |
| | Sulfur (S) | Boron (B) | Phosphorus (P) | (%) |
| Example 1 | 0.087 | 0.03 | 0.262 | 107 |
| Example 2 | 0.189 | 0.044 | 0.301 | 106 |
| Example 3 | 0.041 | 0.021 | 0.239 | 110 |
| Comparative | 0 | 0.021 | 0.239 | 121 |
| Example 1 | | | | |
| Comparative | 0.377 | 0.044 | 0.301 | 118 |
| Example 2 | | | | |

As shown in Table 1, in the nonaqueous electrolyte secondary battery prepared in Example 3, the amount of sulfur contained in the film per square meter of the specific surface area of particles of the positive electrode active material is 0.041 μmol; in the nonaqueous electrolyte secondary battery prepared in Example 1, the amount of sulfur contained in the film per square meter of the specific surface area of particles of the positive electrode active material is 0.087 μmol; and in the nonaqueous electrolyte secondary battery prepared in Example 2, the amount of sulfur contained in the film per square meter of the specific surface area of particles of the positive electrode active material is 0.189 μmol. These nonaqueous electrolyte secondary batteries have a reduced rate of increase in resistance. That is, the increase of resistance can be effectively suppressed.

Such a result is probably as described below. Sulfur contained in a film farmed on a positive electrode active material is probably present in the form of sulfur compounds containing an SO⁻ ion an SO²⁻ ion, an SO³⁻ ion, an SO⁴⁻ ion, or the like. When these sulfur compounds are present on the positive electrode active material, the formation of an insulating layer (for example, NiO) is suppressed in association with oxygen defects at the interfaces between the positive electrode active material and these sulfur compounds. Thus, the increase of resistance is suppressed. When the amount of sulfur contained in the film per square meter of the specific surface area of particles of the positive electrode active material is less than 0.041 μmol, it is conceivable that the formation of the insulating layer is not sufficiently suppressed and therefore the increase of resistance cannot be suppressed. When the amount of sulfur contained in the film per square meter of the specific surface area of particles of the positive electrode active material is more than 0.19 μmol, it is conceivable that the reaction resistance increases with the deintercalation of Li ions.

Incidentally, a film formed on a positive electrode active material preferably contains boron (B). When the film contains boron, the film has reduced resistance and increased Li ion conductivity. This probably allows the reaction resistance to decrease with the deintercalation of Li ions. Furthermore, the effect of suppressing the increase in resistance of the film formed on the positive electrode active material can be obtained.

The amount of boron contained in the film per square meter of the specific surface area of particles of the positive electrode active material is preferably 0.02 μmol to 0.04 μmol. When the amount of boron contained in the film square meter of the specific surface area of particles of the positive electrode active material is 0.02 μmol or more, the increase of resistance can be effectively suppressed. When the amount of boron contained in the film per square meter of the specific surface area of particles of the positive electrode active material is 0.04 μmol or less, the increase of resistance can be more effectively suppressed. Furthermore, the increase, of initial resistance can be suppressed.

The film formed on the positive electrode active material preferably contains phosphorus (P). When the film contains phosphorus, the film has reduced resistance and increased Li ion conductivity. This probably allows the reaction resistance to decrease with the deintercalation of Li ions.

The amount of phosphorus contained in the film per square meter of the specific surface area of particles of the positive electrode active material is preferably 0.02 μmol to 0.04 μmol. Phosphorus contained in the film formed on the positive electrode active material is one derived from lithium difluorophosphate and one derived from LiPF₆ used as an electrolyte salt. The amount of phosphorus derived from LiPF₆ in the film increases with an increase in storage period. Therefore, the amount of phosphorus in the film formed on the positive electrode active material in an initial state is preferably controlled by the amount of an additive.

The positive electrode active material may be a lithium-transition metal composite oxide and the composition thereof is not particularly limited. The lithium-transition metal composite oxide preferably contains at least one of nickel, cobalt, and manganese. The lithium-transition metal composite oxide more preferably contains nickel, cobalt, and manganese. It is preferable that the lithium-transition metal composite oxide contains nickel, cobalt, and manganese and the ratio of the sum of the amounts of nickel and manganese in the lithium-transition metal composite oxide to the sum of the amounts of transition metals in the lithium-transition metal composite oxide is 0.6 or more on a mole basis. In the lithium-transition metal composite oxide, the content of nickel is preferably greater than the content of manganese.

### Others

The positive electrode active material is preferably the lithium-transition metal composite oxide. Examples of the lithium-transition metal composite oxide include lithium cobaltate (LiCoO₂), lithium manganate (LiMn₂O₄), lithium nickelate (LiNiO₂), a lithium-nickel-manganese composite oxide (LiNi₁₋ₓMnₓO₂, where 0<x<1), a lithium-nickel-cobalt composite oxide (LiNi₁₋ₓCoₓO₂, where 0<x<1), and a lithium-nickel-cobalt-manganese composite oxide (LiNiₓCo_{y}Mn_{z}O₂, where 0<x<1, 0<y<1, 0<z<1, and x+y+z=1).

One obtained by adding Al, Ti, Zr, Nb, B, W, Mg, Mo, or the like to the lithium-transition metal composite oxide can be used. For example, the following oxide is cited: a lithium-transition metal composite oxide represented by the formula Li₁₊ₐNiₓCo_{y}Mn_{z}M_{b}O₂, where M is at least one selected from the group consisting of Al, Ti, Zr, Nb, B, Mg, and Mo; 0≤a≤0.2; 0.2≤x≤0.5; 0.2≤y≤0.5; 0.2≤z≤0.4; 0≤b≤0.02; and a+b+x+y+z=1.

A negative electrode active material used may be a carbon material capable of storing and releasing lithium ions. Examples of the carbon material capable of storing and releasing lithium ions include graphite, non-graphitizable carbon, graphitizable carbon, fibrous carbon, coke, and carbon black. Among these materials, graphite is particularly preferable. Furthermore, examples of a non-carbonaceous material include silicon, tin, alloys mainly containing silicon and/or tin, oxides mainly containing silicon and/or tin.

As a nonaqueous solvent (organic solvent) in a nonaqueous electrolyte, carbonates, lactones, ethers, ketones, esters, and the like can be used and mixtures of two or more of these solvents can also be used. For example, the following carbonates can be used: cyclic carbonates such as ethylene carbonate, propylene carbonate, and butylene carbonate and linear carbonates such as dimethyl carbonate, ethyl methyl carbonate, and diethyl carbonate. In particular, a solvent mixture of a cyclic carbonate and a linear carbonate is preferably used. Au unsaturated cyclic carbonate such as vinylene carbonate (VC) may be added to the nonaqueous electrolyte.

As an electrolyte salt in the nonaqueous electrolyte, those used as electrolyte salts in conventional lithium ion secondary batteries can be used. For example, the following salts and mixtures can be used: LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, and LiP(C₂O₄)F₄ and mixtures of these salts. Among these salts, LiPF₆ is particularly preferable. The amount of the electrolyte salt dissolved in the nonaqueous solvent is preferably 0.5 μmol/L to 2.0 mol/L.

A separator used is preferably a microporous separator made of a polyolefin such as polypropylene (PP) or polyethylene (PE). In particular, a separator having a three-layer structure (PP/PE/PP or PE(PP/PE) composed of polypropylene (PP) and polyethylene (PE) is preferably used. The separator may include a heat resistant layer composed of inorganic particles such as alumina particles and a binder. Alternatively, a polymer electrolyte may be used as a separator.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

1. A nonaqueous electrolyte secondary battery comprising:
an electrode assembly including a negative electrode and a positive electrode including a positive electrode active material mix layer containing a lithium-transition metal composite oxide which is a positive electrode active material;
a nonaqueous electrolyte; and
a battery case that houses the electrode assembly and the nonaqueous electrolyte,
wherein the positive electrode active material has a film formed thereon and the film contains 0.04 μmol to 0.19 mol of sulfur per square meter of the specific surface area of particles of the positive electrode active material.

2. The nonaqueous electrolyte secondary battery according to claim 1, wherein the lithium-transition metal composite oxide contains at least one of nickel, cobalt, and manganese.

3. The nonaqueous electrolyte secondary battery according to claim 2, wherein the lithium-transition metal composite oxide contains nickel, cobalt, and manganese and the ratio of the sum of the amounts of nickel and manganese in the lithium-transition metal composite oxide to the sum of the amounts of transition metals in the lithium-transition metal composite oxide is 0.6 or more on a mole basis.

4. The nonaqueous electrolyte secondary battery according claim 1, wherein the film is at least one derived from lithium fluorosulfonate.

5. The nonaqueous electrolyte secondary battery according to claim 1, wherein the film further contains boron and the amount of boron contained in the film per square meter of the specific surface area of particles of the positive electrode active material is 0.02 μmol to 0.04 μmol.

6. The nonaqueous electrolyte secondary battery according to claim 5, wherein the film is at least one derived from lithium fluorosulfonate and lithium bis(oxalato)borate.

7. The nonaqueous electrolyte secondary battery according to claim 1, wherein the film further contains phosphorus and the amount of phosphorus contained in the film per square meter of the specific surface area of particles of the positive electrode active material is 0.24 μmol to 0.30 μmol.
